(19) United States
(12) Patent Application Publication
(10) Pub. No.: US 2019/0225065 A1
(43) Pub. Date: Jul. 25, 2019

(54) BELTLINE PART SOUND INSULATING STRUCTURE OF VEHICLE AND VEHICLE WINDOW GLASS

(71) Applicant: AGC INC., Chiyoda-ku (JP)

(72) Inventor: Daisuke YAMADA, Tokyo (JP)

(73) Assignee: AGC INC., Chiyoda-ku (JP)

(21) Appl. No.: 16/371,183

(22) Filed: Apr. 1, 2019

Related U.S. Application Data
(63) Continuation of application No. PCT/JP2017/036083, filed on Oct. 4, 2017.

(30) Foreign Application Priority Data
Oct. 5, 2016 (JP) 2016-196946

(51) Int. Cl. B60J 10/50; B60J 10/75; B60J 10/33

(52) U.S. Cl. CPC B60J 10/50; B60J 10/33; B60J 10/75

(57) ABSTRACT

A beltline part sound insulating structure of vehicle includes a vehicle door panel having two panel plates facing each other, and seal members arranged in regions along beltlines of facing surfaces of the panel plates; and a window glass arranged between the two panel plates so as to slide between the seal members, including a window glass main body, and at least one of a viscoelastic member arranged on a surface of the window glass main body, the viscoelastic member contacting the panel plate (or the seal member) when the window glass is closed, to seal a gap between the panel plate (or the seal member) and the window glass main body, and a coefficient of static friction at a surface where the viscoelastic member contacts the panel plate (or seal member) being 2.5 (or 2.8) or less.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2017/036083 filed on Oct. 4, 2017 and designating the U.S., which claims priority of Japanese Patent Application No. 2016-196946 filed on Oct. 5, 2016. The entire contents of the foregoing applications are incorporated herein by reference.

### BACKGROUND OF THE INVENTION

### 1. Field of the Invention

The present invention relates to a beltline part sound insulating structure of a vehicle and a vehicle window glass used for the sound insulating structure.

### 2. Description of the Related Art

As one of methods to enhance a sound insulating property of an interior of a vehicle, there has been conventionally adopted a method of providing a sound insulating structure along a beltline of the vehicle. As such a sound insulating structure, for example, Japanese Unexamined Patent Application Publication No. 2000-272937 discloses a sound insulating structure in which, when the window glass is closed, sound insulators are provided in ones of lower end portions of an outer seal portion and an inner seal portion which are mounted on a door panel, and portions corresponding to the lower end portions of the door glass, and projections elastically contacting the sound insulators are provided in the other of the above.

In the sound insulating structure described in Japanese Unexamined Patent Application Publication No. 2000-272937, when the window glass is closed, the door panel, specifically, a gap between the seal member provided on the door panel and the window glass is closed, thereby preventing sound from the outside of the vehicle from entering. However, suppression of sound generated by the vibration of various members including the window glass is not considered.

Moreover, in the sound insulating structure described in Japanese Unexamined Patent Application Publication No. 2000-272937, a sound insulating material moves vertically along with opening/closing of the window glass. At that time, the sound insulating material moves while contacting the door panel or the seal member, and thereby a rubbing sound is generated.

### SUMMARY OF THE INVENTION

### Technical Problem

The present invention provides a beltline part sound insulating structure of a vehicle and a vehicle window glass used for the sound insulating structure, in which an intrusion of sound from the outside of the vehicle through the beltline part and the generation of sound due to the vibration of the window glass itself are suppressed, thereby enhancing a sound insulating state in the vehicle to a high level when the window glass is closed. The present invention also provides a beltline part sound insulating structure and a vehicle window glass, in which rubbing sound of members caused by opening/closing the window glass is suppressed.

### Means for Solving the Problem

According to an aspect of the present invention, a beltline part sound insulating structure of vehicle includes

a vehicle door panel having two panel plates facing each other, and seal members arranged in regions along beltlines of facing surfaces of the panel plates; and

a window glass arranged between the two panel plates so as to slide between the seal members, including a window glass main body, and at least one of

a viscoelastic member arranged on a surface of the window glass main body, the viscoelastic member contacting the panel plate when the window glass is closed, to seal a gap between the panel plate and the window glass main body, and a coefficient of static friction at a surface where the viscoelastic member contacts the panel plate being 2.5 or less, and

a viscoelastic member arranged on the surface of the window glass main body, the viscoelastic member contacting the seal member when the window glass is closed, to seal a gap between the seal member and the window glass main body, and a coefficient of static friction at a surface where the viscoelastic member contacts the seal member being 2.8 or less.

In the following, in the beltline part sound insulating structure of vehicle of the present invention, a beltline part sound insulating structure having the viscoelastic member (A) will be referred to as a sound insulating structure (A), and a beltline part sound insulating structure having the viscoelastic member (B) will be referred to as a sound insulating structure (B).

The present invention provides a vehicle window glass including a glass plate with the viscoelastic member used for the described beltline part sound insulating structure of vehicle.

### Effect of the Invention

A beltline part sound insulating structure of vehicle of the present invention has a high sound insulating performance, in which the amount of sound entering from the outside through the beltline part is suppressed, and generation of sound due to vibration of the window glass itself is suppressed. Thus, when the beltline part sound insulating structure of vehicle of the present invention is installed, a sound insulating state of high level can be achieved in a vehicle when the window glass is closed. Furthermore, the beltline part sound insulating structure of vehicle is a sound insulating structure, in which an occurrence of rubbing sound between members caused by opening/closing of the window glass is suppressed.

When the vehicle window glass of the present invention is mounted on a vehicle, the vehicle window glass can achieve a sound insulating state of high level in the vehicle when the window glass is closed. The vehicle window glass can also configure a beltline part sound insulating structure of vehicle of the present invention, in which an occurrence of rubbing sound between members caused by opening/closing of the window glass is suppressed.

### BRIEF DESCRIPTION OF THE DRAWINGS

FIG. 1 is a side view depicting an example of a vehicle having a beltline part sound insulating structure according to the present invention;

FIG. 2 is a cross sectional view cut along a A-A′-A″ line in FIG. 1 schematically depicting an example of the beltline part sound insulating structure according to the present invention in states where the window glass is closed and the window glass is open;

FIG. 3 is a cross sectional view cut along the A-A′-A″ line in FIG. 1 schematically depicting another example of the beltline part sound insulating structure according to the present invention in states where the window glass is closed and the window glass is open; and

FIG. 4 is a cross sectional view cut along the A-A′-A″ line in FIG. 1 schematically depicting yet another example of the beltline part sound insulating structure according to the present invention in states where the window glass is closed and the window glass is open.

### DETAILED DESCRIPTION OF THE PREFERRED EMBODIMENTS

In the following, embodiments of a beltline part sound insulating structure according to the present invention (hereinafter referred to also simply as a “sound insulating structure”), and a vehicle window glass of the present invention (hereinafter referred to also simply as a “window glass”) will be described with reference to the drawings. Note that the present invention is not limited to the described embodiments, and various variations and modifications may be made in the embodiments without deviating from the scope of the present invention.

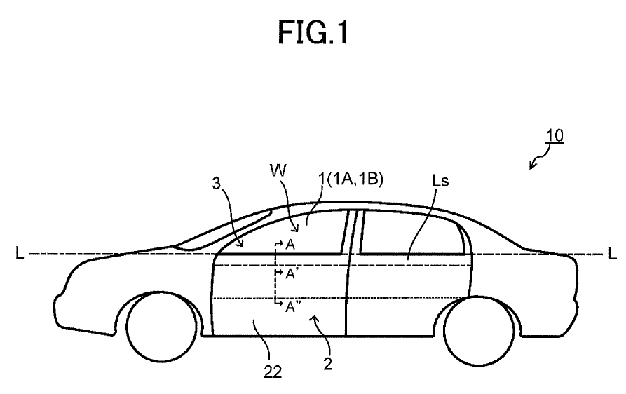

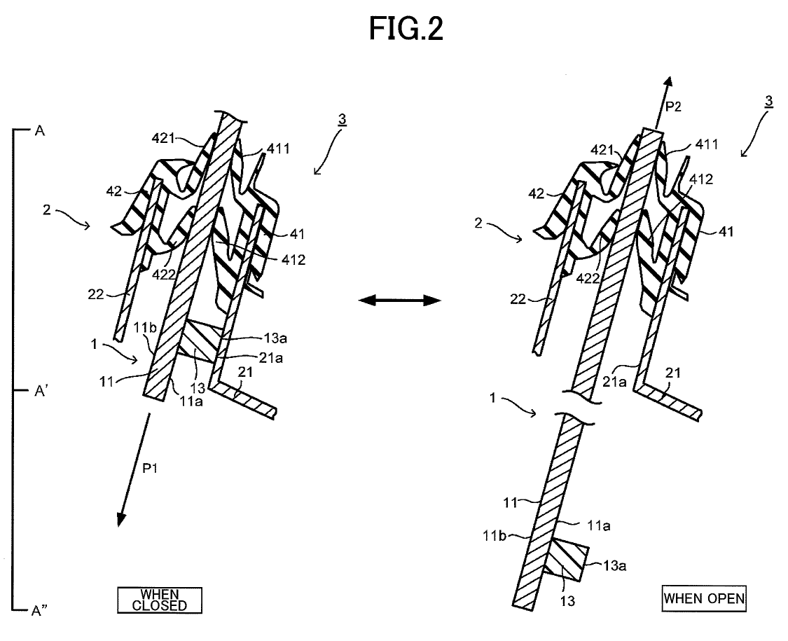

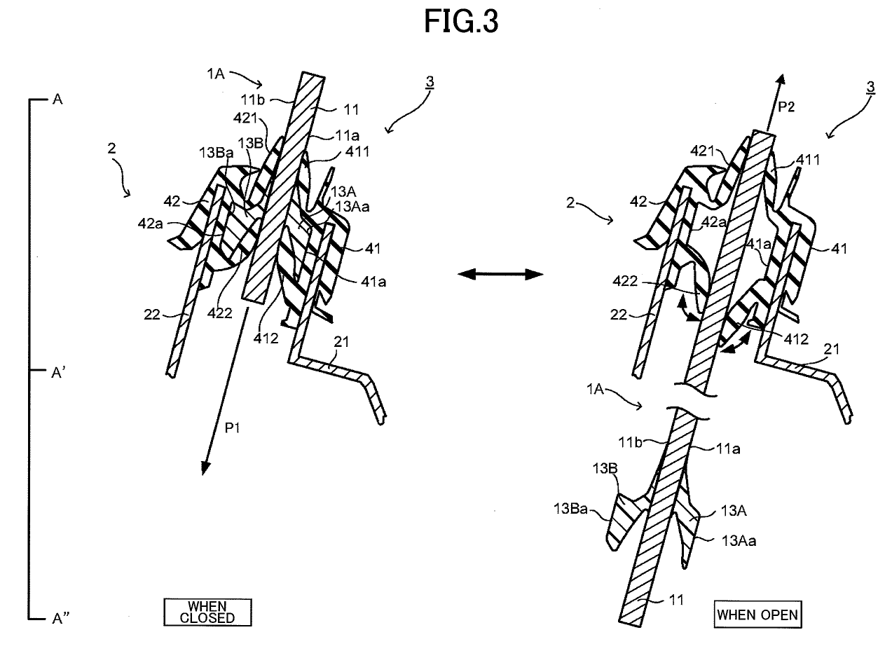

FIG. 1 is a side view depicting a vehicle having a beltline part sound insulating structure of each example according to the embodiments illustrated in FIG. 2, 3 or 4. FIG. 2 is a cross sectional view cut along an A-A′-A″ line in FIG. 1 schematically depicting an example of the embodiment of the sound insulating structure (A). FIG. 3 is a cross sectional view cut along the A-A′-A″ line in FIG. 1 schematically depicting an example of the embodiment of the sound insulating structure (B).

[Sound Insulating Structure (A)]

In a vehicle 10 illustrated in FIG. 1, each of front and rear vehicle doors 3 includes a door panel 2; and a window glass 1 which is arranged on the door panel 2 so as to be vertically movable. FIG. 1 illustrates the vehicle 10 in a state where the window glass 1 is closed.

In the vehicle door 3, the door panel 2 is provided with two panel plates facing each other (In FIG. 1, only a panel plate 22 on the vehicle exterior side is shown), and seal members each provided in a region Ls along a beltline L of a facing surface of the panel plate (in the following, also referred to as a “beltline part”). The window glass 1 is arranged between the two panel plates 21 and 22 of the door panel 2 so as to slide between the seal members 41 and 42 in a vertically manner (FIG. 2). In the vehicle 10, the beltline L is a line connecting upper ends of panel plates 22 for the front and rear vehicle doors 3. The beltline part Ls is a region having a predetermined width downward from an upper end of the panel plate along the beltline L.

The window glass 1 may be opened and closed by being arranged in the vertically movable manner on the door panel 2. The window glass 1 being opened and closed means that a window opening part W located above the vehicle door 3, illustrated in FIG. 1, may be opened and closed by the window glass 1 moving vertically. That is, when the window glass 1 is closed, the window opening part W is closed by the window glass 1. When the window glass 1 is opened, the window opening part W is opened. Note that a dotted line shown in the door panel 2 in FIG. 1 indicates a position of the lowest end of the window glass 1 when the window glass 1 is lowered to the lowest and the window opening part W is fully opened.

FIG. 2 is a cross sectional view schematically depicting the vehicle door 3 having the window glass 1, when the window glass 1 is closed and when the window glass 1 is opened, cut along a line A-A′-A″ in FIG. 1. In the following descriptions, the window glass 1 being closed will be also referred to simply as “when closed”, and the window glass 1 being opened will be also referred to simply as “when open”.

FIG. 2 shows two panel plates 21 and 22 facing each other included in the door panel 2, and seal members 41 and 42 arranged on the beltline parts Ls of the respective facing surfaces of the panel plates 21 and 22. In the specification, a panel plate positioned on a vehicle interior side of the two panels will be referred to as an inner panel, and a panel plate positioned on a vehicle exterior side of the two panels will be referred to as an outer panel. Similarly, a seal member positioned on the vehicle interior side of the two seal members will be referred to as an inner seal member, and a seal member positioned on the vehicle exterior side of the two seal members will be referred to as an outer seal member.

In the door panel 2 illustrated in FIG. 2, the inner panel 21 and the outer panel 22, facing each other, have the inner seal member 41 and the outer seal member 42, respectively, on the beltline parts Ls of the facing surfaces. Moreover, the inner seal member 41 has vertically two lip parts on the window glass 1 side, i.e. an upper inner lip 411 and a lower inner lip 412. Similarly, the outer seal member 42 has an upper outer lip 421 and a lower outer lip 422 on the window glass 1 side.

The inner panel 21 and the outer panel 22 are not particularly limited as long as they are panel plates used for typical door panels. In the typical door panel, a panel plate has a Young's modulus higher than that of a viscoelastic member, and when the window glass 1 is closed, the viscoelastic member 13 is constrained between the window glass main body 11 and the panel plate (inner panel) 21, and thereby a constraining type vibration suppressing structure can be formed.

The inner seal member 41 and the outer seal member 42 may have the same configuration and be formed from the same material as those of a seal member used for a typical door panel. The inner seal member 41 and the outer seal member 42 may be formed of a synthetic rubber such as an ethylene propylene rubber (EPCM rubber) or a thermoplastic elastomer such as a polyolefin based elastomer. In FIG. 2, the inner seal member 41 and the outer seal member 42 have two lip parts, respectively. However, in the configuration of the typical seal member, for example, at least one lip portion may be provided.

In FIG. 2, the cross sectional view of the sound insulating structure (A), depicting a state when the window glass 1 is open (open state), includes a cross sectional view of the entire window glass 1. An opened state and closed state are defined as follows. The opened state is a state in which the window glass 1 is at the lowest position, and the closed state is a state in which the window glass 1 is at the highest position. The window glass 1 moves downward (in a direction of an arrow P1) from the closed state to the opened state; and the window glass 1 moves upward (in a direction of an arrow P2) from the opened state to the closed state. Moreover, when the window glass 1 of the closed state is raised in a direction of an arrow P2, and a state where the window glass 1 is completely raised is the closed state. The window glass 1 includes a window glass main body 11 that functions as a window glass of the vehicle door 3 when the window glass 1 closed, and a viscoelastic member 13 in a lower part of a main surface 11a of the window glass main body 11 on the vehicle interior side.

The window glass main body 11 is not particularly limited as long as it is a transparent plate-like body typically used for a vehicle window. A shape of the window glass includes a flat plate or a curved shape. The main surface 11a is shaped to conform to the window opening part of the vehicle in which the window glass is mounted. The plate-like body may be a general-purpose plate glass, a tempered glass, a multi-layer glass, a laminated glass, and a metal wire-containing glass. The material of the plate-like body includes, a transparent glass, a resin (so-called organic glass), and the like. A thickness of the plate-like body depends on a type of the vehicle, but falls within a range of approximately 2.8-5.0 mm.

The glass specifically may be a typical soda-lime glass, a borosilicate glass, an alkali-free glass, a quartz glass, and the like. A glass that absorbs ultraviolet rays or infrared rays may also be used. The resin may be an acrylic resin such as polymethylmethacrylate and an aromatic polycarbonate resin such as polyphenylene carbonate, a polystyrene resin and the like

The viscoelastic member 13 is arranged at a position, on the main surface 11a of the window glass main body 11 on the vehicle interior side, where, when the window glass is closed, the viscoelastic member 13 contacts the inner panel 21, to seal a gap between the window glass main body 11 and the inner panel 21. That is, when the window glass is closed, the viscoelastic member contacts the inner panel 21, and thereby seals the gap between the window glass main body 11 and the inner panel 21. In the sound insulating structure (A), according to the described configuration, when the window glass 1 is closed, the amount of sound entering the vehicle through the beltline part can be suppressed sufficiently.

Furthermore, in the sound insulating structure (A) included in the vehicle door 3, illustrated in FIG. 2, the viscoelastic member 13 is constrained between the window glass main body 11 and the inner panel 21, and thereby a constraining type vibration suppressing structure is formed. Thus, a vibration of the window glass 1 is sufficiently suppressed, and thereby an excellent sound insulating effect in the vehicle when the window glass 1 is closed can be achieved. Note that a cause of a vibration of the window glass includes a propagation of a road noise from the door panel to the window glass, a propagation of engine noise, and the like.

In the sound insulating structure (A), the coefficient of static friction on a contact surface, where the viscoelastic member 13 contacts the inner panel 21, is 2.5 or less. Thus, the sound insulating structure (A) achieves an excellent sound insulating effect, and it becomes possible to suppress an occurrence of a rubbing sound which may be generated by the viscoelastic member 13 moving while contacting the inner panel 21 whether the window glass 1 is opened or closed. In the following, the coefficient of static friction on a surface where the viscoelastic member contacts the panel plate in the sound insulating structure (A) will be referred to as a coefficient of static friction (A). The coefficient of static friction (A) is preferably 2.0 or less, more preferably 1.5 or less, and further preferably 1.3 or less.

Note that in the present invention, the coefficient of static friction (A) was measured by preparing a test panel plate made of a material similar to that of the panel plate of the vehicle door, to which a window glass is attached, and having a surface (a) similar to the surface, which the viscoelastic member contacts, and a viscoelastic member 13 to be used for the window glass 1, and causing the surface (a) of the test panel plate to contact the surface 13a of the viscoelastic member 13 that contacts the panel plate, on the basis of JIS K7125, using a TriboGear type 14DR by SHINTO Scientific Co., Ltd. Measurement condition was that a load was 2.94 N/4 cm², and a moving speed was 100 mm/sec. The measurement condition corresponds to the condition, in which the viscoelastic member and the panel plate rub against each other when the window glass is opened or closed in an actual vehicle. Measurement results of the coefficient of static friction (A) were, by the present inventors, confirmed to correlate well with the state of an occurrence of a rubbing sound when the window glass was opened or closed in an actual vehicle. The material of a panel plate of a vehicle door is typically a steel sheet.

With respect to the window glass 1, the viscoelastic member 13 is arranged only on the main surface 11a of the window glass main body 11 on the vehicle interior side, so as to seal the gap between the window glass main body 11 and the inner panel 21 when the window glass 1 is closed. However, in addition to the above, the viscoelastic member 13 may also be arranged on a main surface 11b of the window glass main body 11 on the vehicle exterior side, so as to seal a gap between the window glass main body 11 and the outer panel 22 when the window glass 1 is closed. In this case, the coefficient of static friction (A) on the surface where the viscoelastic member 13 contacts the outer panel 22 has the same performance as the coefficient of static friction (A) on the surface where the described viscoelastic member 13 contacts the inner panel 21.

The viscoelastic member 13 may be provided only on the main surface 11b of the window glass main body 11 on the vehicle exterior side. From a viewpoint of enhancing the sound insulating property, the window glass 1 preferably has the viscoelastic member 13 at least on the main surface 11a of the window glass main body 11 on the vehicle interior side.

The viscoelastic member 13 preferably extends horizontally between right and left ends of the window glass main body 11, i.e. parallel with the beltline L. However, the viscoelastic member 13 does not necessarily need to extend continuously in the horizontal direction. In order to obtain the sound insulating effect at a high level by a sealing of the gap between the window glass main body and the door panel and by the constraining type vibration suppressing structure for a window glass, the viscoelastic member 13 is preferably arranged continuously over between the right and left ends of the window glass main body 11 at a predetermined position in the vertical direction on the main surface 11a on the vehicle interior side of the window glass main body 11.

Note that in the case where the viscoelastic member is arranged at a predetermined position in the lower part of the vehicle exterior side main body 11b of the window glass main body 11, from the viewpoint of obtaining the sound insulating effect at a high level, the viscoelastic member is preferably arranged continuously over between the right and left ends, at a predetermined position in the vertical direction of the vehicle exterior side main body 11b of the window glass main body 11. However, on the vehicle exterior side of the window glass 1, rain water or the like enters between the window glass main body 11 and the outer seal member 42. Thus, taking into account good drainage of rain water or the like, in the case where the viscoelastic member is arranged on the vehicle exterior side, the viscoelastic member may have partially a cut in the horizontal direction.

In the window glass 1, the viscoelastic member 13 is preferably moderately elastically deformable. The viscoelastic member 13 is inserted between the window glass main body 11 and the inner panel 21 and constrained while the door glass moves from the position of the opened state to the position of the closed state. Assume that the thickness of the viscoelastic member 13 is somewhat greater than a distance between the window glass main body 11 and the inner panel 21. With an elastically deformable viscoelastic member 13, the viscoelastic member 13 is elastically deformed so that the thickness is gradually decreased from the front side toward the rear side, in the moving direction (P2 direction) of the window glass main body 11. As a result, the thickness of the viscoelastic member 13 when the window is closed is reduced the thickness in the open state. Thus, when the window glass 1 is closed, the gap between the window glass main body 11 and the inner panel 21 can be sealed more tightly, and a more stable constraining type vibration suppressing structure can be formed. Then, the sound insulating effect by the viscoelastic member 13 is enhanced.

The thickness of the viscoelastic member 13 is not particularly limited as long as the viscoelastic member 13 can be constrained between the window glass main body 11 and the inner panel 21, and can be properly set according to an interval between the window glass 1 and the inner panel 21. Moreover, a vertical width of the viscoelastic member 13 is set so that, when the window glass is closed, in the range until the upper end of the viscoelastic member 13 reaches the lower end of the inner seal member 41, a sufficient sound insulating effect is obtained.

The shape of the viscoelastic member 13 not particularly limited as long as the viscoelastic member 13 can seal the gap between the window glass main body 11 and the inner panel 21 when the window glass is closed, i.e. the viscoelastic member 13 can be constrained between the window glass main body 11 and the inner panel 21.

Moreover, a shape of a cross section of the viscoelastic member 13, cut along the vertical direction of the window glass, preferably has a tapered shape that is narrowed toward the upper end, i.e. in the moving direction of the window glass 1 when the window glass 1 is closed (P2 direction). Thus, when the window glass 1 is closed, the viscoelastic member 13 can easily enter the gap between the window glass main body 11 and the inner panel 21. Moreover, the viscoelastic member 13 can easily seal the gap between the window glass main body 11 and the inner panel 21.

The viscoelastic member 13 includes a viscoelastic body. The material of the viscoelastic member 13 is not particularly limited as long as a surface contacting the panel plate 13a (in FIG. 2, a surface contacting the inner panel 21) has a coefficient of static friction (A) that falls within the predetermined range.

The viscoelastic body of the viscoelastic member 13 may be formed using, a synthetic rubber such as an ethylene-propylene rubber (EPDM rubber); a thermoplastic elastomer resin such as a polyolefin-based elastomer; a polyurethane resin, a polyvinyl chloride resin, an epoxy resin silicone gel, a polynorbornene, a fluorine-based rubber, and the like.

Moreover, a part of or whole of the viscoelastic member 13 may be formed from a foam body. Thus, the Young's modulus or a loss coefficient of the viscoelastic member 13 can be adjusted to a desired value. When the viscoelastic member 13 is formed from a foam body, the foam body can be formed, for example, by foaming a foaming raw material by a conventional method. In the case where part of the viscoelastic member 13 is formed from the foam body, at least a part of a surface layer part may be formed from a non-foamed body layer, and the other part may be formed from a foam body, and the surface layer part including at least a surface contacting the inner panel 21 is preferably formed from a non-foamed body layer. The viscoelastic member 13 formed from a non-formed body layer in at least a part of the surface layer part and a foam body in the other part, easily forms a constrained structure by closely contacting the panel plate, and thereby further reduces the static friction, and is preferable. In the case where a part of or whole of the viscoelastic member 13 is formed from a foam body, a density preferably falls within a range of 150 to 700 kg/m³, and more preferably falls within a range of 200 to 600 kg/m³.

Moreover, the viscoelastic member 13 may be formed from a combination of a plurality of materials. That is, the viscoelastic member 13 may include, for example, a single material of the described synthetic rubber, the thermoplastic elastomer resin, or the foam body. Moreover, the viscoelastic member 13 may be formed from a plurality of materials combined two or more materials selected from the described materials. Moreover, a filler such as an organic filler or a mineral filler may be added to the described synthetic rubber, the thermoplastic elastomer resin, the foam body or the like, to form a viscoelastic body.

For the organic filler, for example, crosslinked polyester, polystyrene, styrene-acrylic copolymer resin, a resin particle formed of a resin such as urea resin, a synthetic fiber, or a natural fiber is used. For the mineral filler, for example, calcium carbonate, calcium oxide, magnesium hydroxide, magnesium oxide, magnesium carbonate, aluminum hydroxide, barium sulfate, barium oxide, titanium oxide, iron oxide, zinc oxide, zinc carbonate, a clay such as agalmatolite clay, kaolin clay and calcined clay, mica, diatomaceous earth, carbon black, silica, an inorganic filler such as a glass fiber, a carbon fiber, a fibrous filler, a glass balloon, or the like, is used. By using a material in which a filler is added to the described viscoelastic material, the Young's modulus or the loss coefficient of the viscoelastic member 13 can be adjusted to the desired value.

Moreover, in the viscoelastic member 13, a Young's modulus E (N/m²) at 20° C. and a loss coefficient tan δ at 20° C. and a frequency of 4000 Hz preferably satisfy the following equation (1). In the present specification, unless otherwise specifically noted, the Young's modulus indicates a value at 20° C., and the loss coefficient indicates a value at 20° C. and a frequency of 4000 Hz.

$$E \geq 2.64 \times {10}^{2} \frac{1 + {tan}^{2} δ}{tan δ} \qquad equation ( 1 )$$

In the above-described equation, the Young's modulus E is an index of measuring the hardness of the viscoelastic member 13, and the loss coefficient tan δ is an index for measuring the viscosity of the viscoelastic member 13. When the Young's modulus E and the loss coefficient tan δ fall within ranges that satisfy equation (1), the viscoelastic member 13 in good balance exhibits a sound intrusion prevention effect and a constraining type vibration suppressing effect for the window glass 1, to have an excellent sound insulating effect. In particular, the viscoelastic member 13 can exhibit sufficiently the constraining type vibration suppressing effect on the window glass 1 in the described constraining type vibration suppressing structure.

In the viscoelastic member 13, the loss coefficient tan δ preferably satisfies the following equation (2), and more preferably satisfy the following equation (3).

$$\begin{matrix}E \geq 7.03 \times {10}^{4} \frac{1 + {tan}^{2} δ}{tan δ} & equation ( 2 ) \\ E \geq 1.65 \times {10}^{5} \frac{1 + {tan}^{2} δ}{tan δ} & equation ( 3 )\end{matrix}$$

The viscoelastic member 13 may have a single layer structure composed of a single layer, or a laminated structure including a plurality of layers. When the viscoelastic member 13 has a laminated structure, layers are laminated, for example, in a direction from the window glass main body 11 side to the vehicle interior side. In the case of the laminated structure, in the viscoelastic member 13, the relationship between the Young's modulus of the entire laminated structure and the loss factor preferably satisfies equation (1). A viscoelastic member 13, in the case of a laminated structure, may include a laminated structure of two layers, in which on at least one surface of a soft layer having a relatively low Young's modulus, the other layer other than the soft layer (in the following, also referred to simply as the “other layer”) is arranged, or includes a laminated structure of three or more layers, in which the other layers are arranged on both surfaces of the soft layer. The Young's modulus of the soft layer being relatively low means that the Young's modulus of the soft layer is lower than those of other layers comprising the viscoelastic member 13. The soft layer is preferably formed from a foamed body, for example.

Materials that the viscoelastic member 13 and the inner panel 21 include are described as above. In the case where the viscoelastic member 13 and the inner panel 21 may be prepared using the described materials using conventional methods, there may be a case, in which the coefficient of static friction (A) at the surface where the viscoelastic member 13 contacts the inner panel 21 does not fall into the above-described range. In such a case, the surface 13a of the viscoelastic member 13 that contacts the inner panel 21, and the surface 21a of the inner panel 21 that contacts the viscoelastic member 13, may be subjected to a surface treatment so as to make the coefficient of static friction (A) fall within the above-described range.

The viscoelastic member 13 is bonded to the vehicle interior side main surface 11a of the window glass main body 11. The method of adhesion is not particularly limited, as long as the method has an adhesive strength capable of withstanding a force to peel off the viscoelastic member 13 that occurs when the viscoelastic member 13 is inserted into the gap between the window glass main body 11 and the inner panel 21 or extracted from the gap along with the opening/closing motion of the window glass 1. Specifically, the viscoelastic member 13 can be adhered by a known double-sided tape, an adhesive or the like.

[Sound Insulating Structure (B)]

In the following, an embodiment of a sound insulating structure (B) will be described with reference to FIG. 3. Note that in the sound insulating structure (B), a description for the part that is common to the sound insulating structure (A) will be omitted, and only a part having a different configuration from that of the sound insulating structure (A) will be described below.

In the sound insulating structure (A), the viscoelastic member included in the window glass, when the window glass is closed, contacts the panel plate, and seals the gap between the window glass main body and the panel plate. In the sound insulating structure (B), a viscoelastic member included in the window glass, contacts a seal member, and seals a gap between the window glass main body and the seal member, when the window glass is closed. Furthermore, in the sound insulating structure (A), the coefficient of static friction at a surface where the viscoelastic member contacts the panel plate falls within the described range. In the sound insulating structure (B), the coefficient of static friction at a surface where the viscoelastic member contacts the seal member is 2.8 or less.

FIG. 3 is a cross sectional view schematically depicting the vehicle door 3 having the window glass 1A, when the window glass 1A is closed and when the window glass 1A is opened, cut along the line A-A′-A″ in FIG. 1. A door panel 2 in FIG. 3, has the same configuration as the door panel 2 illustrated in FIG. 2, with the exception that a tip portion of the lower inner lip 412 of the inner seal member 41 and a tip portion of the lower outer lip 422 of the outer seal member 42 are directed to the downward direction, when the window glass 1A is opened. The window glass 1A is mounted on the door panel 2 so that one main surface 11a of the window glass main body 11 is located on the vehicle interior side and the other main surface 11b is located on the vehicle exterior side.

A window glass 1A illustrated in FIG. 3 includes a window glass main body 11 similar to that of the window glass 1 illustrated in FIG. 2. A whole cross sectional view of the window glass 1A is illustrated in FIG. 3 when the window glass 1A is open. The window glass 1A includes a window glass main body 11; a viscoelastic member 13A in a lower part of a vehicle interior side main surface 11a of the window glass main body 11; and a viscoelastic member 13B in a lower part of a vehicle exterior side main surface 11b of the window glass main body 11.

In FIG. 3, an opened state and closed state are defined as follows. The opened state is a state in which the window glass 1A is at the lowest position, and the closed state is a state in which the window glass 1A is at the highest position. The window glass 1A moves downward (in a direction of an arrow P1) from the closed state to the opened state; and the window glass 1A moves upward (in a direction of an arrow P2) from the opened state to the closed state. When the window glass 1A is being closed, i.e. the window glass 1A is raised in the P2 direction, the viscoelastic member 13A and the viscoelastic member 13B are inserted between two lips of the inner seal member 41 and the outer seal member 42. Along with the insertion of the viscoelastic member 13A and the viscoelastic member 13B, the tip portions of the lower inner lip 412 and the lower outer lip 422 change their directions into directions of arrows shown near the respective members. Thus, the window glass finally becomes a closed state.

The viscoelastic member 13A and the viscoelastic member 13B included in the window glass 1A are arranged at predetermined positions in the lower part of the vehicle interior side main surface 11a of the window glass main body 11 and in the lower part of the vehicle exterior side main surface 11b of the window glass main body 11, respectively, so that when the window glass 1A is closed the viscoelastic member 13A and the viscoelastic member 13B are located between the upper inner lip 411 and the lower inner lip 412 and between the upper outer lip 421 and the lower outer lip 422, respectively.

When window glass 1A illustrated in FIG. 3 is closed, the viscoelastic member 13A included in the window glass 1A is located between the upper inner lip 411 and the lower inner lip 412 of the inner seal member 41. Furthermore, an outer peripheral surface of the viscoelastic member 13A contacts substantially entire surface of the inner peripheral surface of the inner seal member 41 on the window glass 1A side. Moreover, similarly, the viscoelastic member 13B included in the window glass 1A is located between the upper outer lip 421 and the lower outer lip 422 of the outer seal member 42. Furthermore, an outer peripheral surface of the viscoelastic member 13B contacts substantially entire surface of the inner peripheral surface of the outer seal member 42 on the window glass 1A side. In the following, the configuration illustrated in FIG. 3 will be described. The viscoelastic member 13A may contact only the lower inner lip 412, or the viscoelastic member 13b may also contact the lower outer lip 422.

In the present specification, “contact substantially entire surface” means that it can be seen as contacting the entire surface viewed by the human eye. In other cases, “substantially” indicates the same meaning as described above.

As illustrated in FIG. 3, when the window glass 1A is closed, the viscoelastic member 13A contacts an inner seal member 41, and the viscoelastic member 13B contacts an outer seal member 42, and thereby a gap between the window glass main body 11 and the door panel 2 is sealed. Thus, the vehicle door 3 can sufficiently suppress the amount of sound entering the vehicle via the beltline part when the window glass is closed.

The window glass 1A is provided with the viscoelastic member 13A and the viscoelastic member 13B on the vehicle interior side main surface 11a and the vehicle exterior side main surface 11b of the window glass main body 11, respectively. In the sound insulating structure (B), the window glass 1A may be provided with either one of the viscoelastic member 13A or the viscoelastic member 13B. From a viewpoint of enhancing the sound insulating property, the window glass 1A is preferably provided with at least the viscoelastic member 13A on the vehicle interior side main surface 11a of the window glass main body 11. Moreover, a structure in the horizontal direction of the viscoelastic member 13A and the viscoelastic member 13B on the window glass 1A can be made the same as the structure in the horizontal direction of the viscoelastic member 13 in the window glass 1.

In this way, in the case where the viscoelastic member included in the window glass contacts the seal member, when the window glass is closed, to seal the gap between the window glass main body and the seal member, the Young's modulus of the viscoelastic member is preferably lower than that of the seal member contacting with the viscoelastic member. In the window glass 1A, illustrated in FIG. 3, the Young's modulus of the viscoelastic member 13A is preferably lower than that of the inner seal member 41, and the Young's modulus of the viscoelastic member 13B is preferably lower than that of the outer seal member 42. A constituent material of the viscoelastic member 13A and the viscoelastic member 13B may be the same as the viscoelastic member 13 in the case of the sound insulating structure (A). Moreover, a constituent material of the inner seal member 41 and the outer seal member 42 may be the same as in the case of the sound insulating structure (A). However, the materials are preferably selected so that the relation between the Young's modulus of the viscoelastic member 13A and the Young's modulus of the inner seal member 41 and the relation of the Young's modulus of the viscoelastic member 13B and the Young's modulus of the outer seal member 42 are the same as the described relations.

When the Young's modulus of the viscoelastic member is lower than that of the seal member contact the viscoelastic member, in the vehicle door 3 illustrated in FIG. 3, the viscoelastic member 13A included in the window glass main body 11 is constrained by the inner seal member 41 and the inner panel 21, thereby the constraining type vibration suppressing structure is formed. Furthermore, the viscoelastic member 13b is constrained by the window glass main body 11, the outer seal member 42 and an outer panel 22, thereby the constraining type vibration suppressing structure is formed. Thus, a vibration of the window glass 1A is sufficiently suppressed, and an excellent sound insulating effect in the vehicle when the window glass 1A is closed can be achieved

Note that the shape of the outer peripheral surface of the viscoelastic member 13A depends on the shape of the inner peripheral surface of the inner seal member 41 on the window glass 1A side. When the window glass is closed, as illustrated in FIG. 3, the viscoelastic member 13A has the outer peripheral surface contacting the substantially entire surface of the inner peripheral surface of the inner seal member 41 on the window glass 1A side. However, in the vehicle door 3, the outer peripheral surface of the viscoelastic member 13A not necessarily contacts the entire surface of the inner peripheral surface of the inner seal member 41 on the window glass 1A side. When the window glass is closed, the viscoelastic member 13A may be arranged between the two inner lips, and contact at least a part of the inner seal member 41.

According to the described configuration, the gap between the window glass main body 11 and the door panel can be sealed. Moreover, when the Young's modulus of the viscoelastic member 13A is lower than that of the inner seal member 41, according to the described configuration, the constraining type vibration suppressing structure for the window glass main body 11 can be obtained. Note that because the sealing of the gap and the excellent sound insulating effect according to the constraining type vibration suppressing for the window glass are obtained, the outer peripheral surface of the viscoelastic member 13A preferably contacts an entire surface of the inner peripheral surface of the inner seal member 41 on the window glass 1A side. The same applies to the relation between the viscoelastic member 13B and the outer seal member 42.

In the vehicle door 3, illustrated in FIG. 3, the viscoelastic member 13A has the outer peripheral surface including a surface 13Aa substantially parallel to the vehicle interior side main surface 11a of the window glass main body 11, and the inner seal member 41 has a surface 41a between the upper inner lip 411 and the lower inner lip 412 facing and being substantially parallel to the vehicle interior side main surface 11a of the window glass main body 11. When the window glass is closed, the surface 13Aa of the viscoelastic member 13A contacts the surface 41a of the inner seal member 41 so that the substantially entire surfaces are coincide with each other.

Moreover, in the same manner, the viscoelastic member 13B has the outer peripheral surface including a surface 13Ba substantially parallel to the vehicle exterior side main surface 11b of the window glass main body 11, and the outer seal member 42 has a surface 42a between the upper outer lip 421 and the lower outer lip 422 facing and being substantially parallel to the vehicle exterior side main surface 11b of the window glass main body 11. When the window glass is closed, the surface 13Ba of the viscoelastic member 13B contacts the surface 42a of the outer seal member 42 so that the substantially entire surfaces are coincide with each other. In the constraining type vibration suppressing structure for the window glass, the viscoelastic member is preferably held between the surface of the window glass main body and the surface parallel to the surface.

In this case, for example, if substantially entire surface of the surface that faces and is substantially parallel to the vehicle interior side surface of the window glass main body included in the inner seal member contacts the viscoelastic member, a lower side of the upper inner lip or an upper side of the lower inner lip not necessarily contacts the viscoelastic member. The same applies to the relation between the outer seal member and the viscoelastic member. The configuration illustrated in FIG. 3 is more preferable.

Moreover, in the sound insulating structure (B), both the coefficient of static friction at the surface where the viscoelastic member 13A contacts the inner seal member 41, and the coefficient of static friction at the surface where the viscoelastic member 13B contacts the outer seal member 42 are 2.8 or less. Thus, the sound insulating structure (B) achieves an excellent sound insulating property, and an occurrence of a rubbing sound, which may be generated, when the window glass 1A is opened or closed, by the viscoelastic member 13A and the viscoelastic member 13B moving and contacting the inner seal member 41 and the outer seal member 42, respectively, can be suppressed. In the following, the coefficient of static friction at the surface where the viscoelastic member contacts the seal member in the sound insulating structure (B) will be referred to as a coefficient of static friction (B). The coefficient of static friction (B) is preferably 2.5 or less, and more preferably 1.5 or less.

Note that in the present invention, a measurement of the coefficient of static friction (B) is performed, by preparing a test seal member made of a material similar to that of the seal member of the vehicle door, to which the window glass is attached, and having a surface (b) similar to the surface, which the viscoelastic member contacts, and viscoelastic members 13A and 13B to be used for the window glass 1A, and causing the surface (b) of the test seal member to contact the surfaces of the viscoelastic members 13A and 13B that contact the seal member, on the basis of JIS K7125, using the same apparatus and under the same condition as for the coefficient of static friction (A), as described above. The test condition corresponds to the condition, in which the viscoelastic member and the seal member rub against each other when the window glass is opened or closed in an actual vehicle. Measurement results of the coefficient of static friction (B) were, by the present inventors, confirmed to correlate well with the state of an occurrence of a rubbing sound when the window glass was opened or closed in an actual vehicle. The described material is typically used for the seal member of a vehicle door.

Here, in the sound insulating structure (B) illustrated in FIG. 3, a substantially entire surface of the outer peripheral surface of the viscoelastic member 13A contacts a substantially entire surface of the inner peripheral surface of the inner seal member 41 on the window glass 1A side. The coefficient of static friction (B) may be measured, for example, by using a test seal member made of a material similar to that of the seal member of the vehicle door, to which the window glass is attached, and having a surface (b) similar to the surface 41a of the inner seal member 41, which faces and is substantially parallel to the vehicle interior side main surface 11a of the window glass main body 11 arranged between the upper inner lip 411 and the lower inner lip 412. Moreover, in the measurement of the coefficient of static friction (B), the surface to contact the surface (b) of the test seal member can be the surface 13Aa of the viscoelastic member 13A. The same applies to the measurement of the coefficient of static friction (B) of the viscoelastic member 13B and the outer seal member 42.

The viscoelastic member 13A and the viscoelastic member 13B are preferably moderately elastically deformable, similar to the viscoelastic member 13, and thicknesses of the viscoelastic members 13A and 13B are reduced when the window glass is closed compared with those when the window glass is open. Moreover, each of the viscoelastic member 13A and the viscoelastic member 13B may have a single layered structure including a single layer or a laminated structure including a plurality of layers. In the case where the viscoelastic member 13A and the viscoelastic member 13B have laminated structures, each of the laminated structures may be the same as that of the viscoelastic member 13.

Moreover, the surface where the viscoelastic member 13A contacts the inner seal member 41 and the surface where the viscoelastic member 13B contacts the outer seal member 42 may be subjected to a surface treatment so as to make the coefficients of static friction (B) fall within the described range, in a range that does not impair the effect of the sound insulating structure (B).

The viscoelastic member 13A and the viscoelastic member 13B are arranged on the window glass main body 11 in the same way as the viscoelastic member 13 arranged on the window glass main body 11.

The sound insulating structure of the present invention may have a configuration in which the sound insulating structure (A) and the sound insulating structure (B) are combined with each other. In this case, the sound insulating structure (A) and the sound insulating structure (B) may be separately provided on the beltline part of the vehicle, or may be provided as an integrated structure.

[Variation of Sound Insulating Structure: Sound Insulating Structure (C)]

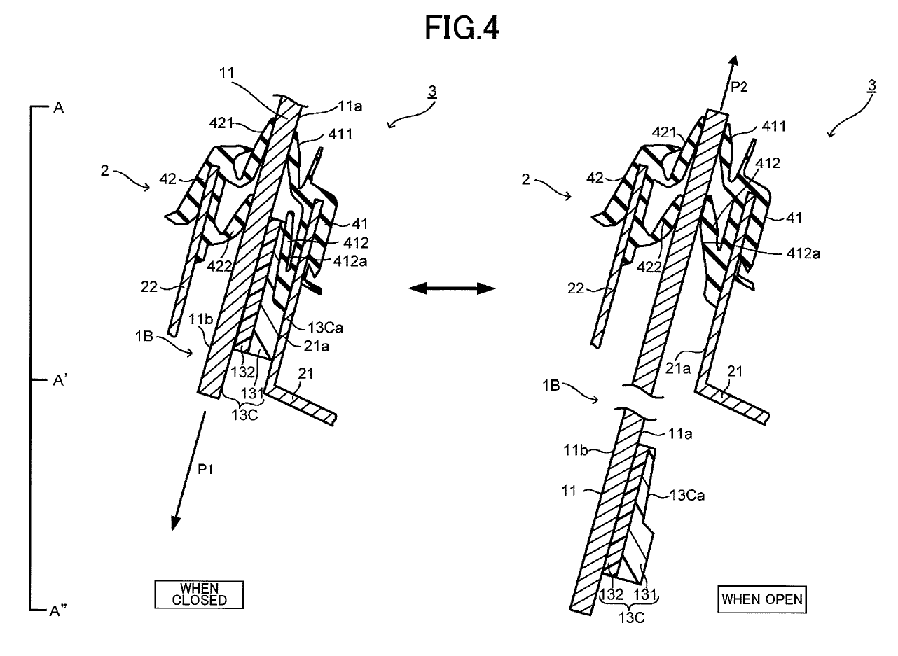

In the following, an example of a variation of the sound insulating structure (sound insulating structure (C)) will be described with reference to FIG. 4. Note that in the sound insulating structure (C), a description of parts common to the sound insulating structure (A) will be omitted, and only parts having a configuration different from the sound insulating structure (A) will be described.

In the sound insulating structure (A), the viscoelastic member included in the window glass contacts the panel plate, when the window glass is closed, to seal the gap between the window glass main body and the panel plate. In the sound insulating structure (C), the viscoelastic member included in the window glass contacts both the panel plate and the seal member, when the window glass is closed, to seal the gap between the window glass main body and the panel plate and the gap between the window glass main body and the seal member. In the sound insulating structure (A), the coefficient of static friction at the surface where the viscoelastic member contacts the panel plate falls within the described range. In the sound insulating structure (B), the coefficient of static friction at the surface where the viscoelastic member contacts the seal member falls within the described range. Thus, in the sound insulating structure (C), the coefficient of static friction at the surface where the viscoelastic member contacts the seal member is 2.8 or less, and the coefficient of static friction at the surface where the viscoelastic member contacts the panel plate is 2.5 or less.

FIG. 4 is a cross sectional view cut along the A-A′-A″ line in FIG. 1 schematically depicting a vehicle door 3 having a window glass 1B in states where the window glass 1B is closed and the window glass is open. A door panel 2 in FIG. 4 has the same configuration as the door panel 2 illustrated in FIG. 2. The window glass 1B is attached to the door panel 2 so that one main surface 11a of the window glass main body 11 is located on the vehicle interior side, and the other main surface 11b is located on the vehicle exterior side.

The window glass 1B illustrated in FIG. 4 has the same window glass main body 11 as the window glass 1 illustrated in FIG. 2. A whole cross-sectional view of the window glass 1B is shown in FIG. 4 of the open state. The window glass 1B includes a window glass main body 11 and a viscoelastic member 13C in a lower part of the vehicle interior side main surface 11a.

In FIG. 4, an opened state and closed state are defined as follows. The opened state is a state in which the window glass 1B is at the lowest position, and the closed state is a state in which the window glass 1B is at the highest position. The window glass 1B moves downward (in a direction of an arrow P1) from the closed state to the opened state; and the window glass 1B moves upward (in a direction of an arrow P2) from the opened state to the closed state. The viscoelastic member 13C included in the window glass 1B seals a gap on the vehicle interior side between the window glass main body 11 and the door panel 2, from the lower inner lip 412 to the inner panel 21, when the window glass is closed. Then, the viscoelastic member 13C included in the window glass 1B is arranged at a predetermined position in a lower part of the vehicle interior side main surface 11a of the window glass main body 11

The viscoelastic member 13C included in the window glass 1B has a cross-sectional shape that can seal a gap on the vehicle interior side between the window glass main body 11 and the door panel 2 from the lower inner lip 412 to the inner panel 21. A viscoelastic member 13C may be a viscoelastic member having a laminated structure of two layers in which a first layer 132 and a second layer 131 are laminated in this order from the window glass main body 11 side. For example, the second layer 131 is a soft layer with a lower Young's modulus than that of the first layer 132. The first layer 132 is the other layer with a higher Young's modulus than that of the second layer 131. The materials that the first layer 132 and the second layer 131 include can be appropriately selected from constituent materials that can be used for the viscoelastic member 13 of the sound insulating structure within a range where the described relation of the Young's modulus is satisfied, respectively.

Note that in the viscoelastic member 13C, a relation between a Young's modulus and a loss coefficient of the entire laminated structure including the first layer 132 and the second layer 131 preferably satisfies described equation (1), more preferably satisfies described equation (2), and further preferably satisfies described equation (3). Furthermore, in the viscoelastic member 13C, the Young's modulus of the entire laminated structure including the first layer 132 and the second layer 131 is preferably lower than the Young's modulus of the inner panel 21 and the Young's modulus of the lower inner lip 412. In this case, for the inner seal member 41 including the lower inner lip 412, a material that satisfies the described relation of the Young's modulus is appropriately selected from the constituent materials for the inner seal member 41 in the sound insulating structure (A). Note that in the typical door panel, the Young's modulus of the panel plate is higher than that of the viscoelastic member.

As described above, by adjusting the Young's modulus of the viscoelastic member 13C, the inner seal member 41, and the inner panel 21, a constraining type vibration suppressing structure, in which the viscoelastic member 13 is constrained between the window glass main body 11 and the panel plate (inner panel) 21 and between the window glass main body 11 and the lower inner lip 412 of the seal member (inner seal member) 41, can be formed when the window glass 1B is closed. The sound insulating structure (C) can sufficiently suppress vibrations of the window glass 1B. Thus, an excellent sound insulating effect in a vehicle can be achieved.

In the window glass 1B, the viscoelastic member 13C is arranged only on the vehicle interior side main surface 11a of the window glass main body 11. In addition to this, the viscoelastic member 13C may be arranged also on the vehicle exterior side main surface 11b of the window glass main body 11. Furthermore, the viscoelastic member 13C may be arranged only on the vehicle exterior side main surface 11b of the window glass main body 11. From the viewpoint of enhancing the sound insulating property, the window glass 1B is preferably provided with at least the viscoelastic member 13C on the vehicle interior side main surface 11a of the window glass main body 11. Moreover, a structure in the horizontal direction of the viscoelastic member 13C on the window glass 1B can be made the same as the structure in the horizontal direction of the viscoelastic member 13 in the window glass 1.

Moreover, in the sound insulating structure (C), a coefficient of static friction at a surface where the viscoelastic member 13C contacts the lower inner lip 412 of the inner seal member 41 (a surface 13Ca of the second layer 131 of the viscoelastic member 13C and a surface 412a of the lower inner lip 412 on the window glass 1B side) is 2.8 or less. Furthermore, a coefficient of static friction at a surface where the viscoelastic member 13C contacts the inner panel 21 (a surface 13Ca of the second layer 131 of the viscoelastic member 13C and a surface 21a of the inner panel 21 on the window glass 1B side) is 2.5 or less. Thus, the sound insulating structure (C) achieves an excellent sound insulating property, and an occurrence of a rubbing sound, which may be generated when the window glass 1B is opened or closed by the viscoelastic member 13C moving and contacting the lower inner lip 412 of the inner seal member 41 and the inner panel 21, respectively, can be suppressed.

In the following, the coefficient of static friction at the surface where the viscoelastic member contacts the seal member will be referred to as a coefficient of static friction (C1), and the coefficient of static friction at the surface where the viscoelastic member contacts the panel plate will be referred to as a coefficient of static friction (C2). The coefficient of static friction (C1) is preferably 2.5 or less, and more preferably 1.5 or less. The coefficient of static friction (C2) is preferably 2.0 or less, more preferably 1.5 or less, and further preferably 1.3 or less.

Note that the coefficient of static friction (C1) is measured as follows. A test seal member made of a material similar to that of the seal member of the vehicle door, to which the window glass is attached, and having a surface (a) similar to the surface of the seal member of the vehicle door, which the viscoelastic member contacts, and viscoelastic member 13C to be used for the window glass 1B are prepared. Then, the surface (a) of the test seal member is caused to contact the surface 13Ca of the viscoelastic member 13C that contacts the seal member. The coefficient of static friction is measured on the basis of JIS K7125 using the same apparatus and under the same condition as for the coefficient of static friction (A).

The coefficient of static friction (C2) is measured as follows. A test panel plate made of a material similar to that of the panel plate of the vehicle door, to which the window glass is attached, and having a surface (a) similar to the surface of the panel plate of the vehicle door, which the viscoelastic member contacts, and viscoelastic member 13C to be used for the window glass 1B are prepared. Then, the surface (a) of the test panel plate is caused to contact the surface 13Ca of the viscoelastic member 13C that contacts the panel plate. The coefficient of static friction is measured on the basis of JIS K7125 using the same apparatus and under the same condition as for the coefficient of static friction (A).

The viscoelastic member 13C is preferably moderately elastically deformable, similarly to the viscoelastic member 13, and a thickness of the viscoelastic member 13C, when the window glass is closed, is preferably thinner than when the window glass is open. Moreover, a shape of a cross section of the viscoelastic member 13C, cut along the vertical direction of the window glass, preferably has a tapered shape that is narrowed toward the upper end, i.e. in the moving direction of the window glass 1B when the window glass 1B is closed (P2 direction).

The viscoelastic member 13C may have a single layered structure including a single layer or a laminated structure including three or more layers. The viscoelastic member 13C may have a laminated structure similar to the laminated structure of the viscoelastic member 13, with the exception of the above-described laminated structure of two layers.

Moreover, the surface where the viscoelastic member 13C contacts the inner seal member 41 and the inner panel 21, e.g. the surface 13Ca of the second layer 131 in the viscoelastic member 13C, the surface 412a on the window glass 1B side of the lower inner lip 412, and the surface 21a on the window glass 1B side of the inner panel 21, may be subjected to a surface treatment that the coefficient of static friction (C1) and the coefficient of static friction (C2) fall within the described range, in a range that does not impair the effect of the sound insulating structure (C).

The arrangement of the viscoelastic member 13C on the window glass main body 11 can be performed in the same way as that of the viscoelastic member 13 on the window glass main body 11.

Note that the window glass having the described configuration used in the sound insulating structure of the present invention can be used as a vehicle window glass of the present invention as a single body.

### EXAMPLE

A relation between a coefficient of static friction and a rubbing sound according to the sound insulating structure (A) and the sound insulating structure (B) was obtained experimentally as follows.

[Sound Insulating Structure (A)]

Five types of viscoelastic members formed from urethanes (1)-(5), respectively, shown in TABLE 1 as a viscoelastic member (20 mm×20 mm, thickness 20 mm), and a sample test panel plate formed from a material of panel plate for vehicle door panel (a high-tension steel sheet) (70 mm×150 mm, thickness 0.7 mm) were prepared, and the coefficient of static friction (A) was measured by using the described method. Note that the urethanes (1)-(5) were urethane moldings, prepared as follows, including a core part formed from a foamed body and a surface layer part formed from a non-foamed body. Moreover, a rubbing sound of the above-described five types of viscoelastic members with the described test panel plate generated in the measurement of coefficient of static friction (A) was detected by human ears, and evaluated according to the following criteria. The results of measurement are shown in TABLE 2. In measuring the coefficient of static friction (A) and the evaluation of the rubbing sound, the non-foamed body layers of the urethanes (1) to (5) contacted the panel plate.

<Preparation of Urethane>

For 100 points by mass of polymeric polyether polyol, 0 to 7 points by mass of a crosslinking agent, 1 part of a tertiary amine catalyst, and water as a foaming agent were added, to prepare a polyol preparation solution previously. An amount of water was adjusted so as to obtain a target density. Thereafter, a predetermined amount of modified 4,4′-diphenylmethane diisocyanate is added to the polyol preparation solution and mixed. A urethane raw material obtained as above was injected into a molding die in which a temperature is adjusted at 60° C., and a urethane molded product is obtained after a predetermined time. Thus, five types of urethane molded products, i.e. the urethanes (1) to (5), containing crosslinking agent and water of the amounts of addition shown in TABLE 1 (amount of addition for 100 points by mass of polymeric polyether polyol) were obtained. The urethanes (1) to (5) obtained as above include a core part formed from a foamed body and a surface layer part formed from a non-foamed body. Densities of the urethane obtained as above are shown in TABLE 1. Note that the urethanes (1) to (5) satisfy the described equations (1)-(3).

TABLE 1

| | crosslinking agent | water | density |
|---|---|---|---|
| | (points by mass) | (points by mass) | (kg/m³) |
| urethane (1) | 7 | 0.5 | 520 |
| urethane (2) | 3 | 0.5 | 490 |
| urethane (3) | 5 | 1.0 | 260 |
| urethane (4) | 2.5 | 1.0 | 250 |
| urethane (5) | 0 | 1.0 | 250 |

<Rubbing Sound Evaluation Criteria>
A: no rubbing sound is generated;
B: rubbing sound is generated but does not feel discomfort; and
C: rubbing sound is generated and feel discomfort.

TABLE 2

| viscoelastic | coefficient of | |
|---|---|---|
| member | static friction (A) | rubbing sound |
| urethane (1) | 5.7 | C |
| urethane (2) | 3.5 | C |
| urethane (3) | 1.5 | B |
| urethane (4) | 1.3 | A |
| urethane (5) | 1.0 | A |

[Sound Insulating Structure (B)]

Five types of viscoelastic members formed from urethanes (1) to (5), shown in TABLE 3 (the same urethanes as the urethanes (1) to (5) in TABLE 1) (20 mm×20 mm, thickness 20 mm), and a sample test seal member formed from a material of seal member for vehicle door panel (EPDM rubber) (20 mm×50 mm, thickness 10 mm) were prepared, and the coefficient of static friction (B) was measured by using the described method. Moreover, a rubbing sound of the above-described five types of viscoelastic members with the described test panel plate generated in the measurement of coefficient of static friction (B) was detected by human ears, and evaluated according to the described criteria. The results of measurement are shown in TABLE 3. In measuring of the coefficient of static friction (B) and evaluating the rubbing sound, the non-foamed body layers of the urethanes (1) to (5) contacted the seal member.

TABLE 2

| viscoelastic | coefficient of | |
|---|---|---|
| member | static friction (B) | rubbing sound |
| urethane (1) | 3.4 | C |
| urethane (2) | 2.5 | B |
| urethane (3) | 1.7 | B |
| urethane (4) | 1.5 | A |
| urethane (5) | 1.2 | A |

[Practical Example]

A sound insulating property was evaluated using a window glass of an actual vehicle as follows. A shape of the urethane (5) was adjusted so as to be a structure of the sound insulating structure (A) or (B), and the urethane (5) was attached to the window glass. Afterwards, the window glass was closed, and the sound insulating property was measured in a state where the non-foamed body layer of the urethane (5) was brought into elastic contact with the panel plate or the seal member. Results of measurement are shown in TABLE 4, as follows. Note that a value of an acoustic transmission loss is the relative difference from a case in which the viscoelastic member is not attached.

TABLE 4

| | acoustic transmission loss [dB] | |
|---|---|---|
| frequency [Hz] | structure (A) | structure (B) |
| 500 | 0.1 | 0.1 |
| 630 | 0.1 | 0.1 |
| 800 | 0.0 | −0.1 |
| 1000 | 0.5 | 0.6 |
| 1250 | 1.1 | 2.0 |
| 1600 | 2.0 | 2.3 |
| 2000 | 0.4 | 0.4 |
| 2500 | 0.4 | 0.2 |
| 3150 | 0.1 | 0.4 |
| 4000 | 0.1 | 0.3 |
| 5000 | 0.0 | 0.0 |
| 6300 | 0.0 | 0.1 |
| 8000 | 0.1 | 0.0 |

As described above, the sound insulating structure of the present invention enhances the sound insulating state in the vehicle at a high level when the window glass is closed, and an occurrence of rubbing sound between members caused by opening/closing of the window glass can be suppressed.

### REFERENCE SIGNS LIST

10 vehicle
L beltline
LS beltline part
1, 1A, 1b window glass
2 door panel
3 vehicle door
11 window glass main body
11a vehicle interior side surface
11b vehicle exterior side surface
13, 13A, 13B, 13B viscoelastic member
21 inner panel
22 outer panel
41 inner seal member
42 outer seal member
411 upper inner lip
412 lower inner lip
421 upper outer lip
422 lower outer lip

What is claimed is:

1. A beltline part sound insulating structure of vehicle comprising:
a vehicle door panel having two panel plates facing each other, and seal members arranged in regions along beltlines of facing surfaces of the panel plates; and
a window glass arranged between the two panel plates so as to slide between the seal members, including a window glass main body, and at least one of
a viscoelastic member arranged on a surface of the window glass main body, the viscoelastic member contacting the panel plate when the window glass is closed, to seal a gap between the panel plate and the window glass main body, and a coefficient of static friction at a surface where the viscoelastic member contacts the panel plate being 2.5 or less, and
a viscoelastic member arranged on the surface of the window glass main body, the viscoelastic member contacting the seal member when the window glass is closed, to seal a gap between the seal member and the window glass main body, and a coefficient of static friction at a surface where the viscoelastic member contacts the seal member being 2.8 or less.

2. The beltline part sound insulating structure of vehicle according to claim 1,
wherein the viscoelastic member is elastically deformable, and a thickness of the viscoelastic member when the window glass is closed is thinner than the thickness of the viscoelastic member when the window glass is open.

3. The beltline part sound insulating structure of vehicle according to claim 1,
wherein in the viscoelastic member, a Young's modulus E (N/m²) at 20° C. and a loss coefficient tan δ at 20° C. and a frequency of 4000 Hz satisfy relation expressed by equation (1)
$$E \geq 2.64 \times {10}^{2} \frac{1 + {tan}^{2} δ}{tan δ} . \qquad equation ( 1 )$$

4. The beltline part sound insulating structure of vehicle according to claim 1,
wherein a shape of a cross section of the viscoelastic member, cut along a vertical direction of the window glass, has a tapered shape that is narrowed toward an upper end.

5. The beltline part sound insulating structure of vehicle according to claim 1,
wherein the viscoelastic member has a laminated structure including a soft layer having a relatively lower Young's modulus at a temperature of 20° C. than a Young's moduli of the other layers.

6. The beltline part sound insulating structure of vehicle according to claim 5,
wherein the soft layer is formed from a foamed body.

7. A window glass for vehicle comprising:
a glass plate with a viscoelastic member used in the beltline part sound insulating structure of vehicle according to claim 1.
